(19) United States
(12) Patent Application Publication
(10) Pub. No.: US 2025/0293308 A1
(43) Pub. Date: Sep. 18, 2025

(54) ELECTRODE ASSEMBLY AND ALL-SOLID STATE BATTERY INCLUDING THE SAME

(71) Applicants: HYUNDAI MOTOR COMPANY, Seoul (KR); Kia Corporation, Seoul (KR)

(72) Inventors: Gyeong Jun CHUNG, Hwaseong-si (KR); Jong Jung KIM, Hwaseong-si (KR); Seung Hwan MOON, Hwaseong-si (KR); Seul Gi CHOI, Hwaseong-si (KR); Ju Yeon LEE, Hwaseong-si (KR); So Ri LEE, Hwaseong-si (KR)

(73) Assignees: HYUNDAI MOTOR COMPANY, Seoul (KR); Kia Corporation, Seoul (KR)

(21) Appl. No.: 18/830,003

(22) Filed: Sep. 10, 2024

(30) Foreign Application Priority Data
Mar. 18, 2024 (KR) 10-2024-0037284

(51) Int. Cl. H01M 10/0585; H01M 4/02; H01M 4/04; H01M 10/0562

(52) U.S. Cl. CPC H01M 10/0585; H01M 4/0404; H01M 10/0562; H01M 2004/021

(57) ABSTRACT

For an electrode assembly having an optimized irregularity structure, an all-solid state battery including the same, a manufacturing method of the electrode assembly, and a manufacturing method of the all-solid state battery, the electrode assembly is manufactured through a wet-wet coating method and has an appropriate irregularity. Thus, exposure of a solid electrolyte contained in an electrode active material layer to moisture is minimized. As a binder migrates to a solid electrolyte layer, a binder distribution within the electrode active material layer is uniform, resulting in excellent durability and electrochemical performance.

### CROSS-REFERENCE TO RELATED APPLICATION

The present application claims priority to Korean Patent Application No. 10-2024-0037284, filed on Mar. 18, 2024, the entire contents of which is incorporated herein for all purposes by this reference.

### BACKGROUND OF THE PRESENT DISCLOSURE

### Field of the Present Disclosure

The present disclosure relates to an electrode assembly that is manufactured using a wet-wet coating method, so that a binder is distributed uniformly, resulting in low interfacial resistance, and an electrode surface is prevented from being deteriorated by exposure to moisture, and an all-solid state battery including the same.

### Description of Related Art

Various batteries that may overcome the limitations of current lithium secondary batteries are being studied in terms of battery capacity, stability, output, large size, and ultra-miniaturization. Among these batteries, an all-solid state battery refers to a battery in which the electrolyte used in existing lithium secondary batteries has been replaced with a solid one. In the all-solid state battery, flammable solvents are not used in the battery, and there is no risk of ignition or explosion due to the decomposition reaction of the conventional electrolyte, so that stability of the battery may be significantly improved.

The all-solid state battery has a stack structure including a cathode and an anode and a solid electrolyte layer interposed between the cathode and the anode. The basic properties required for the solid electrolyte layer are electrical insulation to prevent a short circuit between the cathodes and anodes and ionic conductivity to allow lithium to move smoothly during the charging/discharging process. To achieve this purpose, a resistance at an interface between the solid electrolyte layer and each of the cathode and the anode should be minimized. Factors causing the resistance at the interface include uneven interface contact, increased resistance in an upper layer of the electrode due to migration of a binder contained in an active material layer of the electrode, and creation of a resistor on a surface layer of the electrode due to moisture.

The information included in this Background of the present disclosure section is only for enhancement of understanding of the general background of the present disclosure and may not be taken as an acknowledgement or any form of suggestion that this information forms the related art already known to a person skilled in the art.

### BRIEF SUMMARY

Various aspects of the present disclosure are directed to providing an electrode assembly that may solve the above problems, an all-solid state battery including the same, and a method for manufacturing the electrode assembly and the all-solid state battery.

More specifically, various aspects of the present disclosure are directed to providing an electrode assembly in which a wet-wet coating method is used to minimize binder migration, and exposure of a solid electrolyte to moisture is minimized to lower an interfacial resistance between an electrode active material layer and a solid electrolyte layer, achieving excellent performance and durability, an all-solid state battery including the same, and a method for manufacturing the electrode assembly and the all-solid state battery.

The technical problems to be solved by the present disclosure are not limited to the aforementioned problems, and any other technical problems not mentioned herein will be clearly understood from the following description by those skilled in the art to which the present disclosure pertains.

According to an aspect of the present disclosure, a novel electrode assembly, an all-solid state battery, a manufacturing method of the electrode assembly, and a manufacturing method of the all-solid state battery are provided.

Specifically, (1) the present disclosure provides an electrode assembly including: an electrode including an electrode current collector and an electrode active material layer deposited on the electrode current collector; and a solid electrolyte layer deposited on the electrode active material layer, wherein an interface between the electrode active material layer and the solid electrolyte layer includes at least two or more irregularities, wherein the irregularity indicates a variation in a height of the interface in a thickness direction of the electrode active material layer, wherein a ten point median height (Rz) of the irregularity is in a range of 3 μm to 15 μm, wherein when the electrode is a cathode, a mean spacing (Sm) between irregularities of the at least two or more irregularities is in a range of 15 μm to 30 μm,
wherein when the electrode is an anode, the mean spacing (Sm) between irregularities of the at least two or more irregularities is in a range of 22 μm to 30 μm.
(2) The present disclosure provides the electrode assembly of the (1), wherein the electrode is the cathode, wherein the ten point median height (Rz) of the irregularity is in a range of 3 μm to 6 μm.
(3) The present disclosure provides the electrode assembly of the (1) or (2), wherein the electrode is the cathode, wherein a maximum peak to valley roughness height (Rt) of the irregularity is in a range of 0.5 μm to 15 μm.
(4) The present disclosure provides the electrode assembly of one of the (1) to (3), wherein the electrode is the anode, wherein the ten point median height (Rz) of the irregularity is in a range of 7 μm to 15 μm.
(5) The present disclosure provides the electrode assembly of one of the (1) to (4), wherein the electrode is the anode, wherein a maximum peak to valley roughness height (Rt) of the irregularity is in a range of 5 μm to 20 μm.
(6) The present disclosure provides the electrode assembly of one of the (1) to (5), wherein the electrode assembly satisfies a following Relationship 1:

$$0.85 \leq C ( 0 ) / C ( L ) \leq 1.00 \qquad [ Relationship 1 ]$$

wherein the C(0) denotes a binder concentration value at ab interface between the current collector and the electrode active material layer as obtained from a binder concentration graph obtained through Energy-dispersive X-ray spectroscopy (EDS) analysis of a cross-section in a thickness direction of the electrode assembly,
wherein the C(L) denotes a binder concentration value at the interface between the electrode active material layer and the solid electrolyte layer as obtained from the binder concentration graph obtained through EDS analysis of the cross-section in the thickness direction of the electrode assembly.
(7) The present disclosure provides the electrode assembly of one of the (1) to (6), wherein the electrode assembly satisfies a following Relationship 2:

$$0.1 \leq Minimum value of C ( x ) / Maximum value of C ( x ) \leq 1. \qquad [ Relationship 2 ]$$

wherein the C(x) denotes a binder concentration value at a point x as obtained from a binder concentration graph obtained through EDS analysis of a cross-section in a thickness direction of the electrode assembly.
(8) The present disclosure provides the electrode assembly of one of the (1) to (7), wherein the electrode active material layer includes a sulfide-based solid electrolyte.
(9) The present disclosure provides the electrode assembly of one of the (1) to (8), wherein the electrode active material layer includes a solid electrolyte, wherein a particle size a of a solid electrolyte contained in the electrode active material layer and a particle size b of a solid electrolyte contained in the solid electrolyte layer satisfy a following Relationship 3:

$$0.1 < b / ( a + b ) < 1.0 . \qquad [ Relationship 3 ]$$

(10) The present disclosure provides an all-solid state battery including the electrode assembly according to one of the (1) to (9).
(11) The present disclosure provides a method for manufacturing an electrode assembly, the method including: applying an electrode slurry to an electrode current collector; applying a solid electrolyte slurry on the applied electrode slurry; and simultaneously drying the applied electrode slurry and the applied solid electrolyte slurry, wherein a ratio of a solid content of the solid electrolyte slurry relative to a solid content of the electrode slurry is in a range of 0.60 to 0.90.
(12) The present disclosure provides the method for manufacturing the electrode assembly of the (11), wherein a ratio of a viscosity of the electrode slurry to a viscosity of the solid electrolyte slurry is in a range of 2 to 4.
(13) The present disclosure provides the method for manufacturing the electrode assembly of the (11) or (12), wherein the electrode slurry is a cathode slurry, wherein a solid content of the cathode slurry is in a range of 60 to 80% by weight.
(14) The present disclosure provides the method for manufacturing the electrode assembly of one of the (11) to (13), wherein the electrode slurry is an anode slurry, wherein a solid content of the anode slurry is in a range of 50 to 70% by weight.
(15) The present disclosure provides the method for manufacturing the electrode assembly of one of the (11) to (14), wherein the solid content of the solid electrolyte slurry is in a range of 40 to 60% by weight.
(16) The present disclosure provides a method for manufacturing an all-solid state battery, the method including: applying a cathode slurry to a cathode current collector, applying a first solid electrolyte slurry on the applied cathode slurry, and simultaneously drying the cathode slurry and the first solid electrolyte slurry, manufacturing a cathode-first solid electrolyte stack; applying an anode slurry to an anode current collector, applying a second solid electrolyte slurry on the applied anode slurry, and simultaneously drying the anode slurry and the second solid electrolyte slurry, manufacturing an anode-second solid electrolyte stack; stacking the cathode-first solid electrolyte stack and the anode-second solid electrolyte stack on top of each other so that the first solid electrolyte layer and the second solid electrolyte layer face each other, and rolling the stacking result, wherein at least one of a ratio of a solid content of the first solid electrolyte slurry relative to a solid content of the cathode slurry, and a ratio of a solid content of the second solid electrolyte slurry relative to a solid content of the anode slurry is in a range of 0.70 to 0.80.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a simplified diagram of a structure of the electrode assembly in accordance with the present disclosure;

FIG. 2 shows a flowchart of an electrode assembly manufacturing method in accordance with the present disclosure;

FIG. 3 shows a flowchart of an all-solid state battery manufacturing method in accordance with the present disclosure;

FIG. 4 is a graph of a binder concentration in a cross section of a cathode active material layer obtained for an all-solid state battery in Comparative Example 3-1 of the present disclosure; and

FIG. 5 is a graph of a binder concentration in a cross section of a cathode active material layer obtained for an all-solid state battery of Present Example 3-2 of the present disclosure.

It may be understood that the appended drawings are not necessarily to scale, presenting a somewhat simplified representation of various features illustrative of the basic principles of the present disclosure. The specific design features of the present invention as included herein, including, for example, specific dimensions, orientations, locations, and shapes will be determined in part by the particularly intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments. On the contrary, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Hereinafter, the present disclosure is described in more detail.

Terms or words used in the present specification and claims should not be construed as limited to their ordinary or dictionary meanings. Rather, based on the principle that the inventor may appropriately define the concept of the term to explain his or her invention in the best way, they should be interpreted as meaning and concept consistent with the technical idea of the present disclosure.

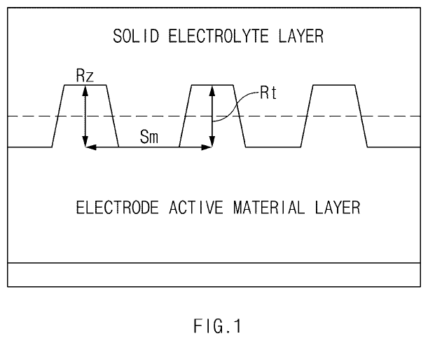

In accordance with the present disclosure, a ten point median height (Rz), a mean spacing between irregularities (Sm), and a maximum peak to valley roughness height (Rt) of an irregularity observed at an interface between an solid electrolyte layer and an electrode active material layer may be measured and calculated from an image of an interface cross-section observed through field emission scanning electron microscopy (FE-SEM). More specifically, the ten point median height, the mean spacing between irregularities, and the maximum peak to valley roughness height may be measured and calculated through a following method based on 220 μm in a longitudinal direction of the cross section, and the Rz, Sm, and Rt values below may refer to a length of a portion shown in FIG. 1.
1) Ten point median height (Rz): Calculated by adding a mean height of five highest peaks and a mean depth of five deepest valleys in a profile in a reference length.
2) Mean spacing between irregularities (Sm): Calculated as a mean value of a unit irregularity length (waviness element) in a reference length.
3) Maximum peak to valley roughness height (Rt): Calculated by adding a maximum peak height value and a maximum valley depth value in a profile in a reference length.
SU7000 from HITACHI may be used as an example of the field emission scanning electron microscope equipment.

### Electrode Assembly

The present disclosure provides an electrode assembly including an electrode including an electrode current collector and an electrode active material layer deposited on the electrode current collector, and a solid electrolyte layer deposited on the electrode active material layer. An interface between the electrode active material layer and the solid electrolyte layer in a cross-section in a thickness direction of the electrode assembly as observed from a scanning electron microscope image includes at least two or more irregularities, wherein the irregularity indicates a variation in a height of the interface in a thickness direction of the electrode active material layer, wherein a ten point median height (Rz) of the irregularity is in a range of 3 μm to 15 μm, wherein when the electrode is a cathode, a mean spacing (Sm) between the irregularities is in a range of 15 μm to 30 μm, wherein when the electrode is an anode, the mean spacing (Sm) between the irregularities is in a range of 22 μm to 30 μm.

### Electrode Current Collector

The electrode current collector should be made of a material that is conductive and has a certain level of durability. More specifically, the electrode current collector may include copper, stainless steel, aluminum, nickel, titanium, fired carbon, or copper or stainless steel surface-treated with carbon, nickel, titanium, silver, etc., and/or aluminum-cadmium alloy. Additionally, the electrode current collector may be in a form of a film, a sheet, a foil, a net, a porous material, a foam, a non-woven material, etc. such that the electrode active material layer is uniformly formed on a surface thereof.

A thickness of the current collector may be in a range of 10 μm to 20 μm, preferably 10 μm to 15 μm. When the thickness of the current collector is within the above-mentioned range, the durability and performance of the electrode may be excellent in a more balanced manner.

### Electrode Active Material Layer

The electrode active material layer is formed on the electrode current collector, and a type of an active material specifically used therefor may vary depending on a type of the electrode.

When the electrode is a cathode, a cathode active material may be an oxide active material or a sulfide active material.

The oxide active material may be a rock salt layer-type active material such as LiCoO₂, LiMnO₂, LiNiO₂, LiVO₂, Li₁₊ₓNi_{1/3}Co_{1/3}Mn_{1/3}O₂, etc., a spinel-type active material such as LiMn₂O₄, Li(Ni_{0.5}Mn_{1.5})O₄, etc., a reverse spinel-type active material such as LiNiVO₄, LiCoVO₄, etc., an olivine-type active material such as LiFePO₄, LiMnPO₄, LiCoPO₄, LiNiPO₄, etc., a silicon-containing active material such as Li₂FeSiO₄, Li₂MnSiO₄, etc., a rock salt layer-type active material in which a portion of a transition metal is replaced with a different metal therefrom, such as LiNi_{0.8}Co_{(0.2-x)} AlₓO₂ (0<x<0.2), a spinel-type active material in which a portion of a transition metal is replaced with a different metal therefrom, such as Li₁₊ₓMn_{2-x-y}M_{y}O₄ (M is at least one of Al, Mg, Co, Fe, Ni, and Zn, and 0<x+y<2), or lithium titanate such as Li₄Ti₅O₁₂, etc. The sulfide active material may be copper chevrel, iron sulfide, cobalt sulfide, nickel sulfide, etc.

In one example, when the electrode is an anode, an anode active material may be a carbon active material or a metal active material.

The carbon active material may be mesocarbon microbeads (MCMB), graphite such as highly oriented pyoytic graphite (HOPG), and amorphous carbon such as hard carbon and soft carbon. The metal active material may be In, Al, Si, Sn, and an alloy containing at least one of these elements.

The electrode active material layer may include a binder along with the active material. The binder is a component that may bind components contained in the electrode active material layer to each other. The electrode active material layer of the electrode assembly in accordance with the present disclosure is characterized by even distribution of the binder within the electrode active material layer because the binder migrates to the solid electrolyte layer as described later during the manufacturing process using wet-wet coating. Types of the binder may include butadiene rubber (BR), nitrile butadiene rubber (NBR), hydrogenated nitrile butadiene rubber (HNBR), polyvinylidene difluoride (PVDF), polytetrafluoroethylene (PTFE), and carboxymethylcellulose (CMC).

The electrode active material layer may include a conductive material. The conductive material is used to ensure electrical conductivity of the electrode active material layer, and may be carbon black, conducting graphite, ethylene black, or graphene.

The electrode active material layer may include a solid electrolyte, and the solid electrolyte may be, more specifically, an oxide-based solid electrolyte or a sulfide-based solid electrolyte, and preferably a sulfide-based solid electrolyte. The solid electrolyte may have a lithium ion conductivity of 0.3 mS/cm or greater. The sulfide-based solid electrolyte has the advantage of high lithium ion conductivity, but has the disadvantage of being vulnerable to moisture. However, when using the wet-wet coating method in the electrode assembly manufacturing method of the present disclosure, exposure of the solid electrolyte contained in the electrode active material layer to moisture may be minimized.

The sulfide-based solid electrolyte is not particularly limited, but may include Li₂S—P₂S₅, Li₂S—P₂S₅—LiI, Li₂S—P₂S₅—LiCl, Li₂S—P₂S₅—LiBr, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅-ZmSn (where x and y are positive numbers, and Z is one of Ge, Zn, and Ga), Li₂S—GeS₂, Li₂S—SiS₂—Li₃PO₄, Li₂S—SiS₂-LiₓMO_{y} (where x and y are positive numbers, and M is one of P, Si, Ge, B, Al, Ga, and In), Li₁₀GeP₂S₁₂, etc.

A content of the active material in the electrode active material layer may be in a range of 75% by weight to 85% by weight, and preferably 80% by weight to 83% by weight. Additionally, a content of the binder may be in a range of 1% by weight to 3% by weight, and preferably 1.5% by weight to 2% by weight. Additionally, a content of the conductive material may be in a range of 1% by weight to 3% by weight, and preferably 1.5% by weight to 2% by weight. Additionally, a content of the solid electrolyte may be in a range of 15% by weight to 25% by weight, and preferably 17% by weight to 20% by weight.

The electrode active material layer may have a thickness in a range of 70 μm to 90 μm, preferably 75 μm to 80 μm.

### Solid Electrolyte Layer

The electrode assembly of the present disclosure includes the solid electrolyte layer deposited on the electrode active material layer as described above. The solid electrolyte layer may include the same binder and the same solid electrolyte as those as described above. The solid electrolyte layer may include a sulfide-based solid electrolyte.

The solid electrolyte layer may have a thickness of 20 μm to 60 μm, preferably 30 μm to 40 μm.

### Interface Between Electrode Active Material Layer and Solid Electrolyte Layer

In the electrode assembly provided by the present disclosure, the interface between the electrode active material layer and the solid electrolyte layer includes at least two or more irregularities, wherein the irregularity indicates a variation in a height of the interface in a thickness direction of the electrode active material layer, wherein a ten point median height (Rz) of the irregularity is in a range of 3 μm to 15 μm, wherein when the electrode is a cathode, a mean spacing (Sm) between the irregularities is in a range of 15 μm to 30 μm, wherein when the electrode is an anode, the mean spacing (Sm) between the irregularities is in a range of 22 μm to 30 μm.

This irregularity may be formed by use of the wet-wet coating method described late. The electrode assembly provided by the present disclosure has the irregularity as described above, so that the electrode assembly has low interface resistance and excellent durability. More specifically, the irregularity of the electrode assembly in accordance with the present disclosure satisfies a specific condition in terms of the mean roughness and the mean spacing between the irregularities, so that the bonding strength between the electrode active material layer and the solid electrolyte layer is excellent, and at the same time, the interfacial resistance therebetween is low.

An exemplary form of the irregularity may vary depending on the type of the electrode. Specifically, the mean spacing between the irregularity when the electrode is a cathode may be different from the mean spacing between the irregularity when the electrode is an anode. When the electrode is the cathode, the mean spacing (Sm) between the irregularities may be in a range of 15 μm to 30 μm, and more specifically, 15 μm or greater, 16 μm or greater, 17 μm or greater, or 18 μm or greater and 30 μm or smaller, 27 μm or smaller, 25 μm or smaller, 23 μm or smaller, or 21 μm or smaller. When the electrode is the anode, the mean spacing (Sm) between the irregularities may be in a range of 22 μm or greater, 22.5 μm or greater, or 23 μm or greater, and 30 μm or smaller, 28 μm or smaller, 27 μm or smaller, or 26 μm or smaller.

In addition, the ten point median height (Rz) of the irregularity may also have a desirable range slightly varying depending on the type of the electrode. When the electrode is a cathode, the ten point median height (Rz) of the irregularity may be 3 μm or greater, 4 μm or greater, or 5 μm or greater, and 6 μm or smaller. When the electrode is an anode, the ten point median height (Rz) of the irregularity may be 7 μm or greater, 8 μm or greater, 9 μm or greater, or 10 μm or greater, and 15 μm or smaller, 14 μm or smaller, or 13 μm or smaller.

The maximum peak to valley roughness height (Rt) of the irregularity may also vary depending on the type of the electrode. When the electrode is a cathode, the maximum peak to valley roughness height (Rt) of the irregularity may be in a range of 0.5 μm to 15 μm. More preferably, the maximum peak to valley roughness height (Rt) of the irregularity may be 0.5 μm or greater, 1 μm or greater, 2 μm or greater, 3 μm or greater, 4 μm or greater, 5 μm or greater, or 6 μm or greater, and 15 μm or smaller, 14 μm or smaller, 13 μm or smaller, 12 μm or smaller, or 11 μm or smaller. When the electrode is an anode, the maximum peak to valley roughness height (Rt) of the irregularity may be 5 μm or greater, 7 μm or greater, 9 μm or greater, 10 μm or greater, 12 μm or greater, 14 μm or greater, or 15 μm or greater and 20 μm or smaller, 19 μm or smaller, or 18.5 μm or smaller.

The reason why the exemplary specific structure of the irregularity varies depending on the type of the electrode is that a size of the active material particles contained in the electrode active material layer varies depending on whether the electrode is a cathode or an anode, and the content of the solid electrolyte used in the electrode active material layer varies depending on whether the electrode is a cathode or an anode. More specifically, the anode active material generally exhibits a larger particle size than that of the cathode active material, and the electrolyte content in the cathode is lower than the electrolyte content in the anode such that the irregularity of the interface at the cathode and the irregularity of the interface at the anode may be slightly different from each other. Conventional equipment may be used as a scanning electron microscope for observing the irregularity, and for example, HITACHI's SU7000 may be used as the scanning electron microscope for observing the irregularity.

In one example, the electrode assembly provided by the present disclosure may be characterized as satisfying a following Relationship 1.

$$0.85 \leq C ( 0 ) / C ( L ) \leq 1.00 \qquad [ Relationship 1 ]$$

The C(0) denotes a binder concentration value at an interface between the current collector and the electrode active material layer obtained from a binder concentration graph obtained through EDS analysis of the cross-section in the thickness direction of the electrode assembly, and the C(L) denotes a binder concentration value at an interface between the electrode active material layer and the solid electrolyte layer obtained from the binder concentration graph obtained through EDS analysis of the cross-section in the thickness direction of the electrode assembly.

The above Relationship 1 means that a ratio of the binder concentration value at the interface between the current collector and the electrode active material layer to the binder concentration value at the interface between the electrode active material layer and the solid electrolyte layer is in a range of 0.85 to 1.00 such that the concentration of the binder is uniform throughout the electrode active material layer. When the electrode active material layer and the solid electrolyte layer are formed using a conventional double coating or transfer scheme, migration of the binder occurs such that the binder concentration value at the interface greatly increases. In the instant case, the C(0)/C(L) value may be low and smaller than 0.85. In the electrode assembly of the present disclosure, the C(0)/C(L) value may be 0.85 or higher, 0.87 or higher, 0.88 or higher, 0.89 or higher, or 0.90 or higher, and 1.00 or lower, 0.97 or lower, 0.95 or lower, or 0.93 or lower.

Additionally, the electrode assembly provided by the present disclosure may be characterized as satisfying a following Relationship 2.

$$0.1 \leq Minimum value of C ( x ) / Maximum value of C ( x ) \leq 1. \qquad [ Relationship 2 ]$$

The C(x) denotes a binder concentration value at a point x as obtained from the binder concentration graph obtained through EDS analysis of the cross-section in the thickness direction of the electrode assembly.

Like the Relationship 1, the above Relationship 2 means that the electrode active material layer contained in the electrode assembly of the present disclosure has a uniform binder concentration. In the electrode assembly of the present disclosure, the binder migrates to the solid electrolyte layer during the wet-wet coating process, so that a ratio between the minimum and maximum binder concentrations in the electrode active material layer is low. In an electrode assembly manufactured by a conventional method, the binder concentration in the electrode active material layer changes significantly due to the binder migration, so that the minimum value of C(x)/the maximum value of C(x) is smaller than 0.10.

The binder concentration graph C(x) may be obtained by measuring a distribution of a specific element contained in the binder through EDS analysis in an image of the cross section of the electrode active material layer through field emission scanning electron microscopy (FE-SEM), and expressing the distribution based on a value in a longitudinal direction of the cross section. For example, when the binder is polyvinylidene fluoride (PVDF), the specific element may be fluorine (F).

In the electrode assembly provided by the present disclosure, the electrode active material layer includes the solid electrolyte. The particle size a of the solid electrolyte contained in the electrode active material layer and the particle size b of the solid electrolyte contained in the solid electrolyte layer may satisfy a following Relationship 3.

$$0.1 < b / ( a + b ) < 1. \qquad [ Relationship 3 ]$$

When the particle size of the solid electrolyte contained in the electrode active material layer and the particle size of the solid electrolyte contained in the solid electrolyte layer satisfy the above-mentioned Relationship 3, there is a technical advantage in that deterioration of the electrode due to the moisture may be suppressed. The b/(a+b) value may be greater than 0.1 or greater than or equal to 0.12, and lower than 1.0, 0.9 or lower, 0.8 or lower, 0.7 or lower, or 0.65 or lower.

The electrode assembly provided by the present disclosure may be a cathode assembly or an anode assembly.

### All-Solid State Battery

The present disclosure provides an all-solid state battery including the electrode assembly as described above.

More specifically, the all-solid state battery may include both the cathode assembly and the anode assembly according to an exemplary embodiment of the present disclosure. In the instant case, the all-solid state battery may have a stack structure in which the cathode assembly and the anode assembly are stacked on top of each other so that the solid electrolyte layer of the cathode assembly faces the solid electrolyte layer of the anode assembly.

In another example, the all-solid state battery may include only one of the cathode assembly and an anode assembly according to an exemplary embodiment of the present disclosure. In the instant case, an electrode opposite to the electrode assembly being included in the all-solid state battery may be manufactured by a conventional method.

When the all-solid state battery of the present disclosure includes the anode assembly according to an exemplary embodiment of the present disclosure, the cathode may be manufactured by a conventional method. The anode may or may not include the solid electrolyte layer on the anode active material layer.

Conversely, when the all-solid state battery of the present disclosure includes the anode assembly according to an exemplary embodiment of the present disclosure, the cathode may be manufactured by a conventional method. The cathode may or may not include the solid electrolyte layer on the cathode active material layer.

### Manufacturing Method of Electrode Assembly

The present disclosure provides a manufacturing method of the electrode assembly as described above. The wet-wet coating method used to manufacture the electrode assembly in accordance with the present disclosure includes applying a slurry composition to form an active material layer on a substrate, applying an electrolyte slurry composition to form a solid electrolyte layer thereon without drying the former slurry composition, and then drying the former and latter slurry compositions together, forming the active material layer and the solid electrolyte layer at once. In the wet-wet coating method, interlayer agitation occurs at the interface between the active material layer and the solid electrolyte layer and the binder migrates to the solid electrolyte layer. Thus, the binder concentration in the electrode surface layer is reduced compared to a conventional coating method such that an electrode assembly with an uniform binder distribution in the active material layer may be obtained. Additionally, because the process is carried out while the electrode active material layer is covered with the solid electrolyte layer, exposure of the electrode active material layer to the moisture may be minimized such that the deterioration of the electrode active material layer due to the moisture may be suppressed.

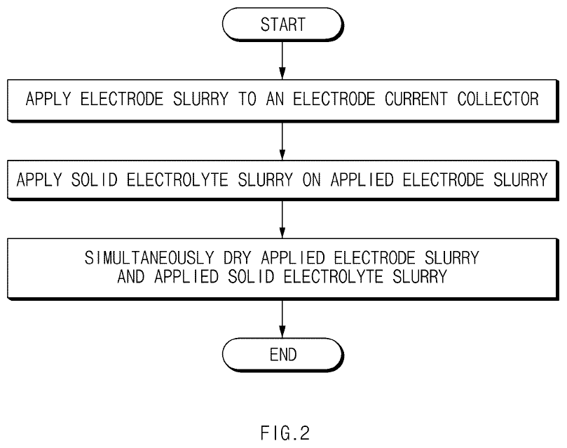

More particularly, as shown in FIG. 2, the present disclosure provides a method for manufacturing an electrode assembly, the method including: applying an electrode slurry to an electrode current collector; applying a solid electrolyte slurry on the applied electrode slurry; and simultaneously drying the applied electrode slurry and the applied solid electrolyte slurry, wherein a ratio of a solid content of the solid electrolyte slurry relative to a solid content of the electrode slurry is in a range of 0.60 to 0.90.

In the electrode assembly manufacturing method of the present disclosure, it was identified that the irregularity formed when the ratio of the solid contents of the electrode slurry and the solid electrolyte slurry is within a certain range is desirable and particularly the ratio of the solid content of the solid electrolyte slurry relative to the solid content of the electrode slurry may be 0.60 or greater, 0.65 or greater, or 0.70 or greater, and 0.90 or lower, 0.85 or lower, or 0.80 or lower. When the solid content ratio is too low or high, the interface resistance of the manufactured electrode assembly may be high or durability thereof may be low.

In the electrode assembly manufacturing method of the present disclosure, a ratio of a viscosity of the electrode slurry relative to a viscosity of the solid electrolyte slurry may be in a range of 2 to 4, and preferably, 2 or greater or 2.5 or greater, and 4 or lower or 3.5 or lower. When the viscosity ratio of the two slurries is not appropriate, during the process of applying the solid electrolyte slurry after applying the electrode slurry, a problem may occur where the underlying electrode slurry is pushed or the two slurries are mixed with each other, resulting in the active material layer separated from the underlying layer.

The solid content of the electrode slurry may vary depending on the type of the electrode. When the electrode slurry is a cathode slurry, the solid content of the cathode slurry may be in a range of 60% by weight to 80% by weight, more preferably 60% by weight or greater or 65% by weight or greater, and 80% by weight or smaller or 75% by weight or smaller.

When the electrode slurry is an anode slurry, the solid content of the anode slurry may be in a range of 50% by weight to 70% by weight, more preferably, 50% by weight or greater or 55% by weight or greater and 70% by weight or smaller or 65% by weight or smaller.

To increase the energy density, it is necessary to increase a thickness of the cathode. Thus, to increase the thickness of the cathode, the solid content of the slurry should be increased to prevent formation of cracks as much as possible in drying the electrode. For this purpose, the solid content of the cathode slurry may have a higher value than that of the anode slurry.

In addition, the solid content of the solid electrolyte slurry may be in a range of 40 to 60% by weight, preferably 40% by weight or greater or 45% by weight or greater, and 60% by weight or smaller or 55% by weight or smaller. When the solid content of the solid electrolyte slurry is within the above-mentioned range, the solid electrolyte layer may be formed more easily.

In one example, the application and the drying in this step may be performed according to conventional methods. A temperature of the drying may vary depending on a type of the slurry solvent. However, the drying may generally be carried out at a temperature of 80° C. to 100° C. The application scheme is not particularly limited as long as it may uniformly apply the slurry. For example, the application may be done using a blade.

Manufacturing Method of all-Solid State Battery

The present disclosure provides a manufacturing method of an all-solid state battery including a process for manufacturing a cathode assembly and an anode assembly using the electrode assembly manufacturing method as described above.

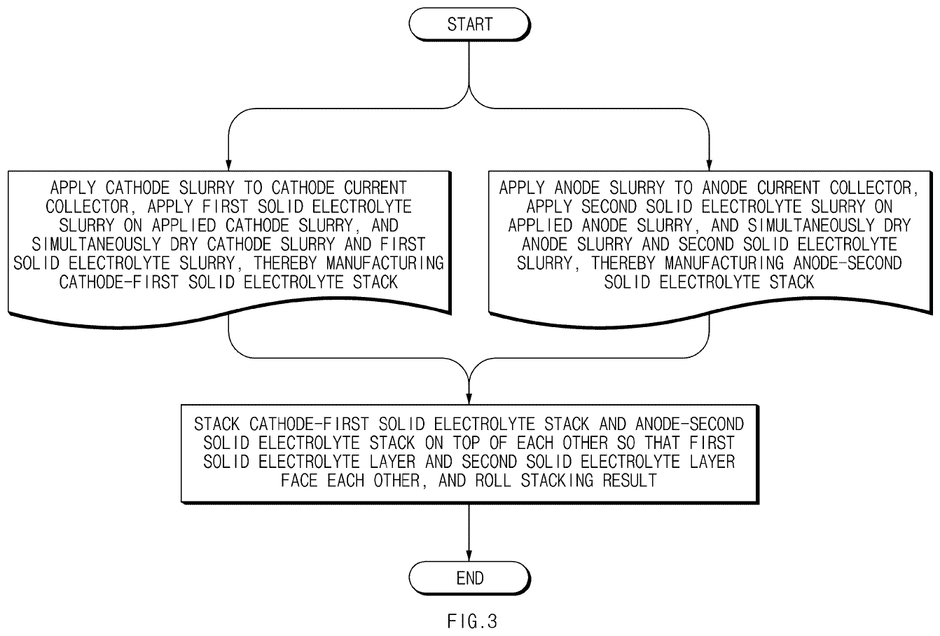

As shown in FIG. 3, the present disclosure provides a method for manufacturing an all-solid state battery, the method including: applying a cathode slurry to a cathode current collector, applying a first solid electrolyte slurry on the applied cathode slurry, and simultaneously drying the cathode slurry and the first solid electrolyte slurry, manufacturing a cathode-first solid electrolyte stack; applying an anode slurry to an anode current collector, applying a second solid electrolyte slurry on the applied anode slurry, and simultaneously drying the anode slurry and the second solid electrolyte slurry, manufacturing an anode-second solid electrolyte stack; stacking the cathode-first solid electrolyte stack and the anode-second solid electrolyte stack on top of each other so that the first solid electrolyte layer and the second solid electrolyte layer face each other, and rolling the stacking result, wherein at least one of a ratio of a solid content of the first solid electrolyte slurry relative to a solid content of the cathode slurry, and a ratio of a solid content of the second solid electrolyte slurry relative to a solid content of the anode slurry is in a range of 0.70 to 0.80.

As previously described, the all-solid state battery may be manufactured by stacking the cathode assembly and anode assembly of the present disclosure on top of each other so that the solid electrolyte layers face each other. The contents applied to the manufacturing method of the electrode assembly provided by the present disclosure may be applied equally to the manufacturing method of the all-solid state battery.

Hereinafter, the present disclosure will be described in more detail through examples. However, the following examples are intended to illustrate the present disclosure and do not limit the scope of the present disclosure.

### <Manufacture of Electrode Assembly>

### Present Example 1-1. Manufacturing of Anode Assembly

An argyrodite-based sulfide-based solid electrolyte was used as a solid electrolyte, hexylbutylate was used as a solvent, and carbon black was used as a conductive material. The solid electrolyte, the solvent, the conductive material, and dispersant were mixed with each other, and first mixing was performed thereon using a PD mixer. Afterwards, a binder solution (PVDF) was added thereto, and secondary mixing was performed thereon using a PD mixer. Finally, a carbon-based active material as an anode active material was added thereto and final mixing was performed thereon to prepare an anode slurry. It was identified that the solid content of the prepared anode slurry was 62% by weight, and the viscosity thereof was 5,780 cP (temperature: 23° C.). Separately, a solid electrolyte slurry was prepared by mixing the same solid electrolyte, solvent, binder solution, and dispersant as the above solid electrolyte, solvent, binder solution and dispersant with each other and performing mixing thereon using a PD mixer. It was identified that the solid content of the prepared solid electrolyte slurry was 49% by weight, and the viscosity thereof was 2,720 cP (temperature: 23° C.). The solid electrolyte slurry solid content/the anode slurry solid content is about 0.790.

The anode slurry prepared previously was applied to an anode current collector made of nickel using a blade, and the solid electrolyte slurry was applied again thereon using the same blade. Afterwards, an anode assembly was manufactured by drying the anode slurry and the solid electrolyte slurry at 90° C. for 15 minutes and vacuum drying at 100° C. for 4 hours.

### Comparative Example 1-1. Manufacturing of Anode Assembly

The same procedure as in Present Example 1-1 was performed, except that the solid content of the solid electrolyte slurry was changed so that the solid electrolyte slurry solid content/the anode slurry solid content was 1.0. Thus, an anode assembly was manufactured.

### Comparative Example 1-2. Manufacturing of Anode Assembly

The anode slurry used in Present Example 1-1 was applied to the nickel-based anode current collector using a blade, then dried at 90° C. for 15 minutes, and vacuum dried at 100° C. for 4 hours. Thus, an anode assembly was manufactured.

### Present Example 2-1. Manufacturing of Cathode Assembly

An argyrodite-based sulfide-based solid electrolyte was used as a solid electrolyte, hexylbutylate was used as a solvent, and carbon black was used as a conductive material. The solid electrolyte, the solvent, the conductive material, and dispersant were mixed with each other, and first mixing was performed thereon using a PD mixer. Afterwards, a binder solution (PVDF) was added thereto, and secondary mixing was performed thereon using a PD mixer. Finally, a NCM-based cathode active material was added thereto and final mixing was performed thereon to prepare a cathode slurry. It was identified that the solid content of the prepared cathode slurry was 70.5% by weight, and a viscosity thereof was 5,000 cP (temperature: 23° C.).

Separately, a solid electrolyte slurry was prepared by mixing a different type of argyrodite-based sulfide-based solid electrolyte from the above type of argyrodite-based sulfide-based solid electrolyte, and the same solvent, binder solution, and dispersant as the solvent, binder solution, and dispersant with each other and performing mixing thereon using a PD mixer. It was identified that the b/(a+b) value as calculated based on the particle size of the solid electrolyte contained in the cathode slurry, and the particle size of the solid electrolyte contained in the solid electrolyte slurry was 0.6, the solid content of the prepared solid electrolyte slurry was 49% by weight, and a viscosity thereof was 2,720 cP (temperature: 23° C.). The solid electrolyte slurry solid content/the cathode slurry solid content is about 0.695.

The cathode slurry prepared previously was applied to an aluminum-based cathode current collector using a blade. The solid electrolyte slurry was applied thereon using the same blade. Afterwards, a cathode assembly was manufactured by drying the cathode slurry and the solid electrolyte slurry at 90° C. for 15 minutes and vacuum drying at 100° C. for 4 hours.

### Present Example 2-2. Manufacturing of Cathode Assembly

An argyrodite-based sulfide-based solid electrolyte was used as a solid electrolyte, hexylbutylate was used as a solvent, and carbon black was used as a conductive material. The solid electrolyte, the solvent, the conductive material, and dispersant were mixed with each other, and first mixing was performed thereon using a PD mixer. Afterwards, a binder solution (PVDF) was added thereto, and secondary mixing was performed thereon using a PD mixer. Finally, a NCM-based cathode active material was added thereto and final mixing was performed thereon to prepare a cathode slurry. It was identified that the solid content of the prepared cathode slurry was 70.5% by weight, and a viscosity thereof was 6,000 cP (temperature: 23° C.).

Separately, a solid electrolyte slurry was prepared by mixing a different type of argyrodite-based sulfide-based solid electrolyte from the above type of argyrodite-based sulfide-based solid electrolyte, and the same solvent, binder solution, and dispersant as the solvent, binder solution, and dispersant with each other and performing mixing thereon using a PD mixer. It was identified that the b/(a+b) value as calculated based on the particle size of the solid electrolyte contained in the cathode slurry, and the particle size of the solid electrolyte contained in the solid electrolyte slurry was 0.125, the solid content of the prepared solid electrolyte slurry was 49% by weight, and a viscosity thereof was 2,720 cP (temperature: 23° C.). The solid electrolyte slurry solid content/the cathode slurry solid content is about 0.695.

The cathode slurry prepared previously was applied to an aluminum-based cathode current collector using a blade. The solid electrolyte slurry was applied thereon using the same blade. Afterwards, a cathode assembly was manufactured by drying the cathode slurry and the solid electrolyte slurry at 90° C. for 15 minutes and vacuum drying at 100° C. for 4 hours.

### Comparative Example 2-1. Manufacturing of Cathode Assembly

The cathode slurry used in Present Example 2-1 was applied to the aluminum-based cathode current collector using a blade. Afterwards, a cathode assembly was manufactured by drying the slurry at 90° C. for 15 minutes and vacuum drying at 100° C. for 4 hours.

### Comparative Example 2-2. Manufacturing of Cathode Assembly

The cathode slurry used in Present Example 2-2 was applied to the aluminum-based cathode current collector using a blade. Afterwards, a cathode assembly was manufactured by drying the slurry at 90° C. for 15 minutes and vacuum drying at 100° C. for 4 hours.

<Manufacture of all-Solid State Battery>

The cathode assembly and the anode assembly prepared in each of the above Present Examples and Comparative Examples were stacked on top of each other such that the respective solid electrolyte layers thereof face each other. The resulting structure was rolled to manufacture an all-solid state battery. The electrode assemblies used in each of Present examples or Comparative Examples was summarized and shown in Table 1 below.

TABLE 1

| | Anode assembly | Cathode assembly |
|---|---|---|
| Present Example 3-1 | Present Example 1-1 | Comparative Example 2-1 |
| Present Example 3-2 | Present Example 1-1 | Present Example 2-1 |
| Present Example 3-3 | Present Example 1-1 | Comparative Example 2-2 |
| Present Example 3-4 | Present Example 1-1 | Present Example 2-2 |
| Comparative Example 3-1 | Comparative Example 1-1 | Comparative Example 2-1 |
| Comparative Example 3-2 | Comparative Example 1-2 | Comparative Example 2-1 |

### Experimental Example 1. Identification of Characteristics of Interfacial Irregularity Structure

The cross-section in the thickness direction of each of the cathode assembly and the anode assembly manufactured in each of the above Present Examples and Comparative Examples was observed with a scanning electron microscope to obtain an image. Based on the obtained image, the ten point median height (Rz) of the irregularity, the mean spacing between irregularities (Sm), and the maximum peak to valley roughness height (Rt) of the irregularity were identified. The results on the anode assembly are summarized in Table 2, and the results on the cathode assembly are summarized in Table 3.

TABLE 2

| | Rz(μm) | Rt(μm) | Sm(μm) |
|---|---|---|---|
| Present Example 1-1 | 11.04 | 16.54 | 23.56 |
| Comparative | 16.01 | 23.2 | 33.34 |
| Example 1-1 | | | |
| Comparative | 7.83 | 6.2 | 21.32 |
| Example 1-2 | | | |

TABLE 3

| | Rz(μm) | Rt(μm) | Sm(μm) |
|---|---|---|---|
| Present Example 2-1 | 5.56 | 6.42 | 19.12 |
| Present Example 2-2 | 5.3 | 10.5 | 18.1 |
| Comparative | 2.99 | 0.49 | 31.92 |
| Example 2-1 | | | |
| Comparative | 2.99 | 0.49 | 31.92 |
| Example 2-2 | | | |

As summarized in Tables 2 and 3 above, it was identified that in the anode assembly of Comparative Example 1-1 which is not manufactured through the manufacturing method in accordance with the present disclosure, and in which the ratio of the solid content of the solid electrolyte slurry relative to the solid content of the electrode slurry is excessively large during the wet-wet coating process, all of the ten point median height (Rz) of the irregularity, the mean spacing between irregularities (Sm), and the maximum peak to valley roughness height (Rt) of the irregularity are higher than those in the electrode assembly in accordance with the present disclosure. It was identified that in the anode assembly of Comparative Example 1-2 and the cathode assembly of Comparative Example 2-1 which were manufactured using a conventional method without using the wet-wet coating, all of the ten point median height (Rz) of the irregularity, the mean spacing between irregularities (Sm), and the maximum peak to valley roughness height (Rt) of the irregularity are lower than those in the anode assembly and the cathode assembly in accordance with the present disclosure.

From this fact, to form the irregularity of the optimal structure for the present disclosure, it is not enough to simply apply the wet-wet coating method but it is further required that that the solid contents of the applied electrode slurry and the solid electrolyte slurry should be controlled within an appropriate range when applying the wet-wet coating method. As will be described later, the electrode assembly that satisfies the irregularity required by the present disclosure may exhibit excellent electrochemical performance.

### Experimental Example 2. Electrochemical Performance Evaluation of all-Solid State Battery

Electrochemical performance evaluation was conducted on each of the all-solid state batteries of Present Examples 3-1 to 3-4 and Comparative Example 3-1 and Comparative Example 3-2.

Specifically, the all-solid state battery was charged and discharged for first two cycles at a voltage of 2.0 to 4.25V, a current of 0.2 C (8.6 mA), and a temperature of 30° C., and then was charged and discharged at 0.33 C (14.2 mA). At this time, rate evaluation was conducted. Afterwards, durability evaluation was conducted by measuring the capacity retention rate while charging and discharging the battery at a rate of 0.2 C. In the all-solid state battery in Comparative Example 3-1, a hard short circuit occurred, making charging and discharging operations impossible. The results are summarized in Tables 4 and 5 below.

TABLE 4

| | 1^{st} Cycle(0.2 C) | | | | |
|---|---|---|---|---|---|
| | | | | Average | |
| | Charge[mAh/g] | Discharge[mg] | Ah/Efficiency[%] | voltage[V] | DC-IR[Ω] |
| Comparative | 217.0 | 191.2 | 88.1 | 3.34 | 11.17 |
| Example 3-2 | | | | | |
| Present | 215.9 | 189.7 | 87.9 | 3.37 | 8.81 |
| Example 3-1 | | | | | |
| Present | 219.9 | 193.0 | 87.8 | 3.38 | 7.92 |
| Example 3-2 | | | | | |
| Present | 218.4 | 186.0 | 85.2 | 3.36 | 9.55 |
| Example 3-3 | | | | | |
| Present | 219.9 | 190.0 | 86.4 | 3.41 | 7.28 |
| Example 3-4 | | | | | |

TABLE 5

| | | | | | 7^{th} durability | |
|---|---|---|---|---|---|---|
| | 2^{nd} Cycle(0.2 C) | | 4^{th} Cycle(0.33 C) | | evaluation(0.2 C) | |
| | | 0.2 C(2^{nd})/ | | 0.33 C/ | | Lifetime |
| | Discharge | 0.2 C(1^{st}) | Discharge | 0.2 C(2^{nd}) | Discharge | 21^{th}/7^{th} |
| | [mAh/g] | [%] | [mAh/g] | [%] | [mAh/g] | [%] |
| Comparative | 181.4 | 94.9 | 163.0 | 89.9 | 167.8 | 94.7 |
| Example 3-2 | | | | | | |
| Present | 181.6 | 95.7 | 166.8 | 91.9 | 170.2 | 94.8 |
| Example 3-1 | | | | | | |
| Present | 186.8 | 96.8 | 174.3 | 93.3 | 179.2 | 95.9 |
| Example 3-2 | | | | | | |
| Present | 179.3 | 96.4 | 164.1 | 91.4 | 170.7 | 94.6 |
| Example 3-3 | | | | | | |
| Present | 185.1 | 97.4 | 172.9 | 93.3 | 176.0 | 94.3 |
| Example 3-4 | | | | | | |

As may be identified from Tables 4 and 5 above, the all-solid state batteries of Present Examples 3-1 to 3-4 using the electrode assembly of the present disclosure exhibited lower resistance and better durability performance compared to the all-solid state battery in Comparative Example 3-2 using the electrode assembly of the Comparative Example.

### Experimental Example 3. Identification of Binder Concentration Distribution

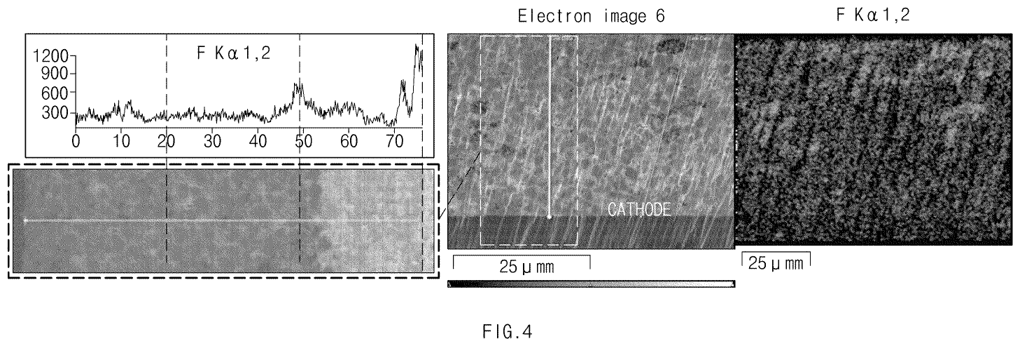

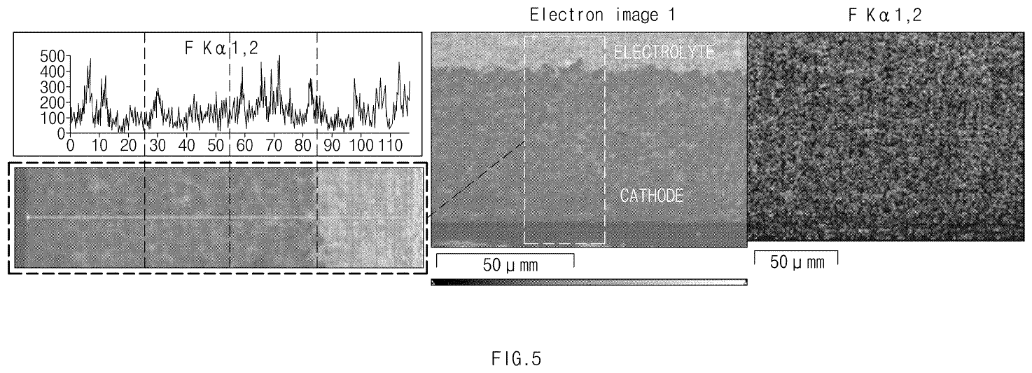

In the all-solid state batteries of Comparative Example 3-1 and Present Example 3-2, graphs of the binder concentrations in the cathode active material layer and the solid electrolyte interface was obtained and shown in FIG. 4 and FIG. 5, respectively. More specifically, the binder concentration graph C(x) was obtained by measuring a distribution of the fluorine element contained in the polyvinylidene fluoride (PVDF) as the binder through EDS analysis in an image of the cross section of the electrode active material layer through field emission scanning electron microscopy (FE-SEM), and expressing the distribution based on a value in a longitudinal direction of the cross section. In addition, the binder concentration values in the cross section of the cathode active material layer of Comparative Example 3-1 and Present Example 3-2 were calculated as relative values and summarized in Table 6 below.

TABLE 6

| | Binder concentration(relative value) | | |
|---|---|---|---|
| | Base(x = 0) | Middle | Surface(x = L) |
| Comparative | 56.0 | 88.3 | 100.0 |
| Example 3-1 | | | |
| Present | 91.8 | 69.9 | 100.0 |
| Example 3-2 | | | |

As identified from the comparison of FIG. 4 and FIG. 5 and Table 6 above, the all-solid state battery according to the exemplary embodiment of the present disclosure exhibited a uniform binder distribution in the cathode active material layer area, whereas the all-solid state battery according to the Comparative Example exhibited that the binder concentration increased as the distance from the current collector increased. That is, in the all-solid state battery of the Comparative Example, binder migration occurs within the cathode active material layer, so that the binder concentration in the outermost cathode active material layer is significantly high. However, in the all-solid state battery of Present Example, the binder of the cathode active material layer migrates to the solid electrolyte layer such that the binder distribution is evenly distributed within the cathode active material layer.

From this fact, it was identified that the all-solid state battery of the present disclosure had the uniform binder distribution in the active material layer and thus has excellent electrochemical properties.

In the electrode assembly in accordance with the present disclosure, the interface between the electrode active material layer and the solid electrolyte layer has the irregularities satisfying the specific condition, so that the resistance at the interface between the electrode active material layer and the solid electrolyte layer is low and the binder distribution is uniform. Thus, the all-solid state battery including the electrode assembly may have excellent output and durability characteristics.

In addition, in the electrode assembly manufacturing method in accordance with the present disclosure, the electrode active material layer and the solid electrolyte layer are formed at once through the wet-wet coating method, minimizing binder migration and minimizing the exposure of the solid electrolyte to the moisture. Optimizing the ratio of the solid contents of the slurries forming the two layers may allow the electrode assembly with lowered interfacial resistance between the electrode active material layer and the solid electrolyte layer to be manufactured.

The foregoing descriptions of specific exemplary embodiments of the present invention have been presented for purposes of illustration and description. They are not intended to be exhaustive or to limit the present disclosure to the precise forms disclosed, and obviously many modifications and variations are possible in light of the above teachings. The exemplary embodiments were chosen and described to explain certain principles of the present disclosure and their practical application, to enable others skilled in the art to make and utilize various exemplary embodiments of the present invention, as well as various alternatives and modifications thereof. It is intended that the scope of the present disclosure be defined by the Claims appended hereto and their equivalents.

What is claimed is:

1. An electrode assembly comprising:
an electrode including an electrode current collector and an electrode active material layer deposited on the electrode current collector; and
a solid electrolyte layer deposited on the electrode active material layer,
wherein an interface between the electrode active material layer and the solid electrolyte layer includes at least two or more irregularities, wherein the irregularity indicates a variation in a height of the interface in a thickness direction of the electrode active material layer,
wherein a ten point median height (Rz) of the irregularity is in a range of 3 μm to 15 μm,
wherein when the electrode is a cathode, a mean spacing (Sm) between irregularities of the at least two or more irregularities is in a range of 15 μm to 30 μm,
wherein when the electrode is an anode, the mean spacing (Sm) between irregularities of the at least two or more irregularities is in a range of 22 μm to 30 μm.

2. The electrode assembly of claim 1, wherein the electrode is the cathode and the ten point median height (Rz) of the irregularity is in a range of 3 μm to 6 μm.

3. The electrode assembly of claim 1, wherein the electrode is the cathode and a maximum peak to valley roughness height (Rt) of the irregularity is in a range of 0.5 μm to 15 μm.

4. The electrode assembly of claim 1, wherein the electrode is the anode and the ten point median height (Rz) of the irregularity is in a range of 7 μm to 15 μm.

5. The electrode assembly of claim 1, wherein the electrode is the anode and a maximum peak to valley roughness height (Rt) of the irregularity is in a range of 5 μm to 20 μm.

6. The electrode assembly of claim 1, wherein the electrode assembly satisfies a following Relationship 1:
$$0.85 \leq C ( 0 ) / C ( L ) \leq 1.00 \qquad [ Relationship 1 ]$$
wherein the C(0) denotes a binder concentration value at an interface between the current collector and the electrode active material layer as obtained from a binder concentration graph obtained through Energy-dispersive X-ray spectroscopy (EDS) analysis of a cross-section in a thickness direction of the electrode assembly,
wherein the C(L) denotes a binder concentration value at the interface between the electrode active material layer and the solid electrolyte layer as obtained from the binder concentration graph obtained through EDS analysis of the cross-section in the thickness direction of the electrode assembly.

7. The electrode assembly of claim 1, wherein the electrode assembly satisfies a following Relationship 2:
$$0.1 \leq Minimum value of C ( x ) / Maximum value of C ( x ) \leq 1. \qquad [ Relationship 2 ]$$
wherein the C(x) denotes a binder concentration value at a point x as obtained from a binder concentration graph obtained through EDS analysis of a cross-section in a thickness direction of the electrode assembly.

8. The electrode assembly of claim 1, wherein the electrode active material layer includes a sulfide-based solid electrolyte.

9. The electrode assembly of claim 1,
wherein the electrode active material layer includes a solid electrolyte, and
wherein a particle size a of a solid electrolyte contained in the electrode active material layer and a particle size b of a solid electrolyte contained in the solid electrolyte layer satisfy a following Relationship 3:
$$0.1 < b / ( a + b ) < 1.0 . \qquad [ Relationship 3 ]$$

10. An all-solid state battery including the electrode assembly according to claim 1.

11. A method for manufacturing an electrode assembly, the method comprising:
applying an electrode slurry to an electrode current collector;
applying a solid electrolyte slurry on the applied electrode slurry; and
simultaneously drying the applied electrode slurry and the applied solid electrolyte slurry,
wherein a ratio of a solid content of the solid electrolyte slurry relative to a solid content of the electrode slurry is in a range of 0.60 to 0.90.

12. The method of claim 11, wherein a ratio of a viscosity of the electrode slurry to a viscosity of the solid electrolyte slurry is in a range of 2 to 4.

13. The method of claim 11, wherein the electrode slurry is a cathode slurry and a solid content of the cathode slurry is in a range of 60 to 80% by weight.

14. The method of claim 11, wherein the electrode slurry is an anode slurry and a solid content of the anode slurry is in a range of 50 to 70% by weight.

15. The method of claim 11, wherein the solid content of the solid electrolyte slurry is in a range of 40 to 60% by weight.

16. A method for manufacturing an all-solid state battery, the method comprising:
applying a cathode slurry to a cathode current collector, applying a first solid electrolyte slurry on the applied cathode slurry, and simultaneously drying the cathode slurry and the first solid electrolyte slurry, manufacturing a cathode-first solid electrolyte stack;
applying an anode slurry to an anode current collector, applying a second solid electrolyte slurry on the applied anode slurry, and simultaneously drying the anode slurry and the second solid electrolyte slurry, manufacturing an anode-second solid electrolyte stack;
stacking the cathode-first solid electrolyte stack and the anode-second solid electrolyte stack on top of each other so that the first solid electrolyte layer and the second solid electrolyte layer face each other, and rolling the stacking result,
wherein at least one of a ratio of a solid content of the first solid electrolyte slurry relative to a solid content of the cathode slurry, and a ratio of a solid content of the second solid electrolyte slurry relative to a solid content of the anode slurry is in a range of 0.70 to 0.80.
